(19) United States
(12) Patent Application Publication
(10) Pub. No.: US 2025/0127195 A1
(43) Pub. Date: Apr. 24, 2025

(54) METHOD FOR MANUFACTURING INSTANT NOODLES TO BE RECONSTITUTED WITH WATER

(71) Applicant: NISSHIN FLOUR MILLING INC., Tokyo (JP)

(72) Inventors: Shingo AKIKUSA, Chuo-ku (JP); Minori YAMADA, Chuo-ku (JP); Takao NAGAI, Chuo-ku (JP); Yasuyuki TSUDA, Chuo-ku (JP); Yoko ISONO, Chuo-ku (JP)

(73) Assignee: NISSHIN FLOUR MILLING INC., Tokyo (JP)

(21) Appl. No.: 18/705,800

(22) PCT Filed: Oct. 28, 2022
(86) PCT No.: PCT/JP2022/040322

§ 371 Date: Apr. 29, 2024

(30) Foreign Application Priority Data
Nov. 2, 2021 (JP) 2021-179206

(51) Int. Cl. A23L 7/113

(52) U.S. Cl. CPC A23L 7/113

(57) ABSTRACT

A method for manufacturing instant noodles to be reconstituted with water including preparing raw noodle strings each having a thickness of 0.93 mm or less from a raw material powder containing wheat flour and a glutinous starch selected from glutinous potato starch and glutinous tapioca starch. A mass ratio of the wheat flour and the glutinous starch in the raw material powder is from 65:35 to 15:85.

### TECHNICAL FIELD

The present invention relates to a method for manufacturing instant noodles to be reconstituted with water.

### BACKGROUND ART

Instant noodles have not only excellent long-shelf-life, but are also highly convenient foods that can be eaten after simple cooking. Instant noodles are generally produced by pregelatinizing raw noodles and then frying them in oil or drying them by a method such as using hot air, microwave heating, or freeze drying, and are reconstituted to be able to be eaten by pouring boiling water and leaving them for several minutes.

In a case where boiling water is not available such as in an emergency, it is also possible to reconstitute the instant noodles with water (tap water or the like) at normal temperature. However, in a case where conventional common instant noodles are reconstituted with water at room temperature, not only does it take more than ten and several minutes for the instant noodles to be ready to eat, but also the instant noodles are not easily loosened, so that the reconstitution unevenness easily occurs. In addition, in the case of reconstitution with water, even if reconstitution is performed over a sufficient time, there is a problem unique to reconstitution with water, such as lack of smoothness and remaining hardness in the texture of the reconstituted noodles.

Techniques for improving reconstitution property of instant noodles have been proposed. Patent Literature 1 describes water-reconstituted dried noodles that can be eaten and have a good texture simply by being immersed in normal temperature water, in which the starch has a gelatinization degree within a range of 70% or more and 99% or less. Patent Literature 2 describes a method for manufacturing instant noodles which are easy to eat simply by pouring water and have an excellent texture after reconstitution, in which an aqueous solution obtained by dissolving 0.5 to 5% (w/w) of common salt is added to pregelatinized wheat starch having a pregelatinization degree of 80% or more and a swelling power of 10 or more, or a composition obtained by substituting 2 to 15% (w/w) of the gelatinized wheat starch with a separated protein so as to have a moisture content of 30 to 50% (w/w), and the noodles are prepared, and then dried. Patent Literature 3 describes that instant noodles which contains starch of roots or tubers containing at least 95 wt % of amylopectin based on dry matter, or contains derivatives thereof can be reconstituted with water at a lower temperature or in a shorter time. Patent Literature 4 describes that by adding active gluten to at least one of an etherified starch selected from a hydroxyethyl starch, a hydroxypropyl starch, and a carboxymethyl starch having a degree of substitution (D.S.) of 0.005 to 0.3, or an esterified starch selected from an acetic acid starch, a succinic acid starch, an octenylsuccinic acid starch, and a maleic acid starch, the problem of reconstitution property, texture, and flavor deterioration in non-fried instant noodles can be solved. Patent Literature 5 describes that fried instant noodles manufactured from a noodle dough obtained by blending 0.3 to 5 parts by mass of xanthan gum with 100 parts by mass of a cereal flour raw material containing 60 to 95 parts by mass of a cereal flour mainly composed of wheat flour and 5 to 40 parts by mass of starch can be sufficiently reconstituted even in hot water having a temperature lower than that of boiling water, have a good texture such as viscoelasticity, and are excellent in loosening properties at the time of eating.

### CITATION LIST

### Patent Literature

Patent Literature 1: JP 2016-106630 A
Patent Literature 2: JP 61-5754 A
Patent Literature 3: JP 2008-531042 T
Patent Literature 4: JP 59-55156 A
Patent Literature 5: JP 2019-170348 A

### SUMMARY OF INVENTION

### Technical Problem

The present invention provides instant noodles that can be reconstituted in a short time using water at normal temperature or lower and have a good texture.

### Solution to Problem

The present inventors found that it is possible to produce instant noodles that can be reconstituted in a short time using water at normal temperature or lower and have a good texture by obtaining raw noodle strings with adjusted thickness from a raw material powder containing a predetermined amount of wheat flour and one or more kinds of glutinous starch selected from the group consisting of glutinous potato starch and glutinous tapioca starch, and then manufacturing instant noodles from the raw noodle strings.

As a representative embodiment of the present invention, the following is provided.

[1]A method for manufacturing instant noodles to be reconstituted with water, the method including
preparing raw noodle strings each having a thickness of 0.93 mm or less from a raw material powder containing wheat flour and one or more kinds of glutinous starch selected from the group consisting of glutinous potato starch and glutinous tapioca starch, in which
a mass ratio of the wheat flour and the glutinous starch in the raw material powder is from 65:35 to 15:85.

[2] The method described in [1], in which the glutinous starch contains an esterified starch or an etherified starch.

[3] The method described in [1] or [2], in which the instant noodles to be reconstituted with water are instant noodles to be reconstituted with water at 30° C. or lower.

[4] The method described in any one of [1] to [3] including pregelatinizing the raw noodle strings, and then frying or drying the raw noodle strings.

[5] The method described in [4], in which the instant noodles are fried instant noodles.

[6] The method described in any one of [1] to [5], in which the wheat flour contains wheat flour derived from medium hard wheat as a main component.

[7] The method described in any one of [1] to [6], in which a total amount of the wheat flour and the glutinous starch in the raw material powder is 80 mass % or more.

[8]A use of raw noodle strings in manufacture of instant noodles to be reconstituted with water, in which
the raw noodle strings contain a raw material powder containing wheat flour and one or more kinds of glutinous starch selected from the group consisting of glutinous potato starch and glutinous tapioca starch,
a mass ratio of the wheat flour and the glutinous starch in the raw material powder is 65:35 to 15:85, and
the raw noodle strings each having a thickness of 0.93 mm or less.

[9] The use according described in [8], in which the glutinous starch contains an esterified starch or an etherified starch.

[10] The use described in [8] or [9], in which the instant noodles to be reconstituted with water are instant noodles to be reconstituted with water at 30° C. or lower.

[11] The use described in any one of [8] to [10], in which the instant noodles are prepared by pregelatinizing the raw noodle strings and then frying or drying the raw noodle strings.

[12] The use described in [11], in which the instant noodles are fried instant noodles.

[13] The use described in any one of [8] to [12], in which the wheat flour contains wheat flour derived from medium hard wheat as a main component.

[14] The use described in any one of [8] to [13], in which a total amount of the wheat flour and the glutinous starch in the raw material powder is 80 mass % or more.

[15]A method for manufacturing instant noodles including
bringing the instant noodles manufactured by the method described in any one of [1] to [7] into contact with water at normal temperature or lower for 10 minutes or shorter to reconstitute the instant noodles to an edible state.

### Advantageous Effects of Invention

According to the present invention, it is possible to provide instant noodles which can be reconstituted to a state suitable for eating in a short time even when the instant noodles are reconstituted using water at normal temperature or lower, and which have a good texture.

### DESCRIPTION OF EMBODIMENTS

The instant noodles of the present invention are manufactured by preparing raw noodle strings from a raw material powder containing a predetermined amount of wheat flour and one or more kinds of glutinous starch selected from the group consisting of glutinous potato starch and glutinous tapioca starch, pregelatinizing the obtained raw noodle strings according to a normal procedure for producing instant noodles, and frying or drying the raw noodle strings.

Examples of the instant noodles produced in the present invention include noodle strings such as Chinese noodles, Japanese noodles, Japanese buckwheat noodles, and pasta. However, examples thereof are not limited to these.

The wheat flour contained in the raw material powder of the instant noodles of the present invention may be any flour generally used in the production of noodles, and examples thereof include hard wheat flour, semi-hard wheat flour, moderate wheat flour, soft wheat flour, durum wheat flour, and whole wheat flour. These kinds of flour can be used alone or in combination of two or more kinds thereof.

The wheat flour contained in the raw material powder of the instant noodles of the present invention preferably contains wheat flour derived from medium hard wheat as a main component, and more preferably is wheat flour derived from medium hard wheat. For example, the wheat flour contained in the raw material powder preferably mainly contains moderate wheat flour, and more preferably is moderate wheat flour. The medium hard wheat may be a foreign wheat or a domestic wheat. Examples of the foreign medium hard wheat include Australian Standard White (ASW) and French wheat. Examples of the domestic medium hard wheat include wheat varieties such as Kitahonami, Sato-no-sora, Chikugoizumi, Tsurpikari, Ayahikari, Kinuakari, Iwainodaichi, Shiroganekomugi, Norin No. 61, Sanuki-no-Yume 2009, Biwahonami, and Fukuhonoka, and preferably include Kitahonami, Kinuakari, Sanuki-no-Yume 2009, and Chikugoizumi, and among these, Kitahonami is more preferable. Alternatively, so-called derivatives of these varieties in which these domestic wheat varieties are used as crossbreeding parents can be used. The medium hard wheat exemplified above can be used as a raw material wheat of the wheat flour of the present invention by combining any one kind or two or more kinds.

The glutinous starch is a starch having a higher content of amylopectin than that of a normal starch. Preferably, the glutinous starch is a starch having an amylopectin content of preferably 90 mass % or more, more preferably 93 mass % or more, and even more preferably 95 mass % or more. The amylopectin content of normal potato starch and tapioca starch is about 75 to 80 mass %. The glutinous starch used in the present invention is one or more selected from the group consisting of glutinous potato starch and glutinous tapioca starch. As the glutinous potato starch and the glutinous tapioca starch, those described in JP 2002-538799 A, JP 2002-538801 A, or Patent Literature 3 can be used. In addition, commercially available glutinous starch can be used.

The amylopectin content of the starch can be measured based on the Concanavalin A method, and can be measured using, for example, AMYLOSE/AMYLOPECTIN ASSAY KIT (Megazyme Ltd.).

The glutinous starch used in the present invention may be an unprocessed glutinous starch, a processed glutinous starch, or a combination thereof, and is preferably a processed glutinous starch. The processed glutinous starch can be obtained by processing an unprocessed glutinous starch, by for example, etherification, esterification, crosslinking, or the like. These processing procedures can be performed alone or in a combination of any two or more thereof. Preferably, the processed glutinous starch used in the present invention is an esterified starch or an etherified starch. The esterified starch and the etherified starch may be used in combination. Examples of the esterified starch include acetylated starch, octenylsuccinic acid starch, and acetic acid starch. Examples of the etherified starch include hydroxypropylated starch and carboxymethylated starch. The esterified starch or etherified starch may be crosslinked, and may include, for example, acetylated adipic acid crosslinked starch, acetylated phosphoric acid crosslinked starch, hydroxypropylated phosphorus crosslinked starch, and the like.

Preferably, the raw material powder of the instant noodles of the present invention contains the wheat flour and one or more kinds of glutinous starch selected from the group consisting of glutinous potato starch and glutinous tapioca starch in a total amount of 80 mass % or more. The mass ratio of the wheat flour and the glutinous starch (the total amount of the glutinous potato starch and the glutinous tapioca starch) in the raw material powder may be (wheat flour):(glutinous starch)=65:35 to 15:85, and is preferably 65:35 to 35:65. If the content of the glutinous starch is too small, when the obtained instant noodles are reconstituted with water at normal temperature or lower, it takes time to reconstitute the instant noodles, and the texture of the reconstituted noodles is deteriorated. On the other hand, if the content of the wheat flour is too small, the texture of the reconstituted noodles may be adversely affected.

The raw material powder used in the present invention may further contain other materials conventionally used for the manufacture of noodles, in addition to the wheat flour and one or more kinds of glutinous starch selected from the group consisting of glutinous potato starch and glutinous tapioca starch. Examples of the other materials include cereal flours other than wheat flour; starches containing unprocessed starch and processed starches other than the glutinous starch; proteins such as gluten, soy protein, and milk protein; fats and oils such as animal and vegetable fats and oils, emulsified fats and oils, and shortening; salt; brine (“kansui”); saccharides; sweeteners; calcined calcium; dietary fiber; spices; seasonings; vitamins, minerals, and nutrition enhancers; dyes; essences; dextrin (including indigestible); leavening agent; emulsifiers; thickeners; humectants; preservatives; enzymatic agents; pH adjusters; redox agents, or the like. However, examples thereof are not limited thereto. These other materials can be used alone or in combination of two or more. In order to improve the noodle manufacturability and texture of noodles, gluten can be added to the raw material powder as necessary, and the amount of the gluten added is preferably 1 to 10 parts by mass, and more preferably 2 to 6 parts by mass per 100 parts by mass of the total amount of the cereal flour and starch in the raw material powder. The total content of the other materials in the raw material powder used in the present invention is preferably 0 to 20 mass %. The formulation amount of each of the other materials in the raw material powder can be appropriately determined according to the type of the target noodles.

In the method for manufacturing instant noodles according to the present invention, raw noodle strings are prepared from the raw material powder. For example, according to a conventional method, water may be added to the raw material powder and kneading performed to prepare a noodle dough, and then noodle strings may be prepared from the noodle dough. As the water used for preparing the noodle dough, water for kneading, for example, water, salt water, or brine water (“kansui solution”), which is usually used for producing noodle dough, can be used. The noodle strings from the noodle dough can be prepared by a usual method. Examples thereof include a method in which a noodle dough is rolled with a noodle making roll to obtain a noodle strip, and the noodle strip is cut out with a cutting blade or the like to obtain noodle strings, and a method in which a noodle dough is extruded and molded to obtain noodle strings.

The thickness of each of the resulting raw noodle strings is adjusted to 0.93 mm or less, preferably 0.9 mm or less, and more preferably 0.8 mm or less. In the present specification, the thickness of each of the noodle strings refers to the shortest width of the cross section of the noodle string (the surface orthogonal to the long axis direction of the noodle string).

In the method for manufacturing instant noodles according to the present invention, the obtained raw noodle strings are pregelatinized by steaming or the like. The pregelatinized noodle strings thus obtained are fried in oil according to a conventional method to produce fried instant noodles. On the other hand, the pregelatinized noodle strings obtained are dried by a method such as using hot air, microwave heating, or freeze drying according to a conventional method, thereby producing non-fried instant noodles. Preferably, the instant noodles manufactured in the present invention are fried instant noodles. For example, the fried instant noodles can be manufactured by filling pregelatinized noodle strings into a mold for each individual meal and frying them at 140 to 150° C. for 1 minute to 3 minutes. Note that, since the noodle strings are expanded or partially puffed by this frying treatment, the thickness of the obtained fried instant noodles is larger than that of the raw noodle strings. In the case of non-fried instant noodles, for example, the pregelatinized noodle strings are packed in a mold for each individual meal and dried with hot air at 90 to 150° C. for about 5 to 25 minutes, whereby non-fried instant noodles can be manufactured. It is preferable to dry with hot air at 110 to 150° C. Since the noodle strings are expanded or partially puffed by this hot air drying treatment, the thickness of the obtained non-fried instant noodles is larger than that of the raw noodle strings.

The instant noodles provided by the present invention can be reconstituted with water, that is, can be reconstituted to be edible by being brought into contact with (preferably immersed in) water at normal temperature or lower. The temperature of water for reconstituting noodles is 0° C. or higher, preferably 40° C. or lower, more preferably 30° C. or lower, and even more preferably 10 to 30° C. The contact time with water for reconstituting the noodles is preferably 10 minutes or shorter. For example, in a case where the water temperature is 20° C., in the case of non-fried instant noodles, the contact time is preferably 10 minutes or shorter, more preferably 7 minutes or shorter, and even more preferably 6 minutes or shorter. In the case of the fried instant noodles, the contact time is preferably 10 minutes or shorter, more preferably 5 minutes or shorter, and even more preferably 4 minutes or shorter. In addition, for both the non-fried instant noodles and the fried instant noodles, the contact time with water for reconstitution is preferably 1.5 minutes or longer, and more preferably 3 minutes or longer. The contact time with the water can be adjusted according to the temperature of water to be used.

It is of course also possible for the instant noodles provided by the invention to be reconstituted with hotter water, for example, water with a temperature in the range of more than 40° C. and boiling point or less. However, the instant noodles of the present invention can be reconstituted to be eaten in a short time without using boiling water or warm water for reconstitution as in the conventional case, and furthermore, the instant noodles have a good texture. As described above, the instant noodles of the present invention are highly convenient because it is not necessary to prepare boiling water or warm water for eating, and delicious food can be enjoyed even in an environment where boiling water or warm water is difficult to obtain, for example, an environment where boiling water is difficult to obtain as in a disaster. Therefore, the instant noodles of the present invention are preferably used as instant noodles to be reconstituted with water, that is, instant noodles for being reconstituted and eaten by being brought into contact with water at normal temperature or lower.

Hereinafter, the present invention will be described in more detail with reference to examples, but the present invention is not limited only to these examples.

### [Materials]

Wheat flour
Moderate wheat flour using Kitahonami as raw wheal
Semi-hard wheat flour using HRW (Hard Red Winter) as raw material wheat
Starch
Glutinous potato starch (amylopectin content: 96.9%)
Acetylated glutinous potato starch (amylopectin content: 96.8%)
Etherified glutinous potato starch (amylopectin content: 96.8%)
Potato starch (unprocessed)
Glutene: A-glu G (GLICO NUTRITION CO., LTD.)
(The amylopectin content of the glutinous starch was measured using AMYLOSE/AMYLOPECTIN ASSAY KIT (Megazyme Ltd.).)

### [Test Example 1] Fried Instant Noodles

### 1) Manufacture of Fried Instant Noodles

A solution prepared by dissolving 3 parts by mass of common salt and 0.2 parts by mass of brine (“kansui”) (“Akakansui” manufactured by Oriental Yeast Co., ltd.) in advance in 30 to 45 parts by mass of water was added to a raw material powder (100 to 108 parts by mass) described in Tables 1, and the mixture was mixed (at a high speed for 3 minutes and then at a low speed for 6 minutes) with a noodle mixer to manufacture a noodle dough. The noodle dough was rolled with a noodle making roll to form a noodle strip having a predetermined thickness (0.9 mm), and then cut with a cutting blade (#19 square) to prepare raw noodle strings. The obtained raw noodle strings were steamed for 3 minutes (steaming pressure: 3 to 8 kPa), then divided into individual meals, and fried (140° C., 2 min) to manufacture fried instant noodles (Chinese noodles).

### 2) Evaluation

The manufactured instant noodles (42 g) were placed in a container, and 400 mL of water at 20° C. was added thereto to reconstitute the noodles. 10 trained panelists evaluated the eating state of the noodles every 30 seconds after the addition of water. Time at which 9 or more of 10 panelists determined that eating was possible up to the center of the noodle lump of instant noodles was determined as the reconstituting time. Further, the texture (unevenness in texture, elasticity, and smoothness) of the noodles when it was determined that the noodles could be eaten was evaluated by the same 10 panelists according to the following criteria, and the average score of the 10 panelists was obtained. The evaluation results are shown in Table 1.

### <Evaluation Criteria of Texture>

### (Unevenness in Texture)

5 points: The degree of reconstitution is uniform, and the texture is extremely good without unevenness.
4 points: Good texture with almost no unevenness
3 points: The texture is slightly uneven, but is slightly good.
2 points: The texture is slightly uneven and slightly poor.
1 point: The unevenness of the texture is severe and poor.

### (Elastic)

5 points: Elasticity is extremely good.
4 points: Elasticity is good.
3 points: Elasticity is slightly good.
2 points: Elasticity is slightly poor.
1 point: Elasticity is poor

### (Smoothness)

5 points: Extremely good.
4 points: Good
3 points: Slightly good
2 points: Slightly poor
1 point: Poor

TABLE 1

| Raw material composition | | Comparative Examples | | | | | | Manufacturing Examples | | | | | |
|---|---|---|---|---|---|---|---|---|---|---|---|---|---|
| (parts by mass) | | 1-1 | 1-2 | 1-3 | 1-4 | 1-5 | 1-6 | 1-1 | 1-2 | 1-3 | 1-4 | 1-5 | 1-6 |
| Moderate wheat flour | | 100 | 65 | 90 | 80 | 70 | | 65 | | 50 | 50 | 35 | 20 |
| Semi-hard flour | | | | | | | 70 | | 65 | | | | |
| Glutinous potato starch | | | | 10 | 20 | 30 | 30 | 35 | 35 | 50 | 50 | 65 | 80 |
| Potato starch | | | 35 | | | | | | | | | | |
| Gluten | | | | | | | | | | | 3 | 5 | 8 |
| Noodle thickness (mm) | | 0.9 | 0.9 | 0.9 | 0.9 | 0.9 | 0.9 | 0.9 | 0.9 | 0.9 | 0.9 | 0.9 | 0.9 |
| Reconstituting time (min) | | 20 | 15 | 15 | 10 | 6 | 7 | 4 | 5 | 3 | 3 | 4 | 5 |
| Texture | Unevenness | 2.1 | 2.3 | 2.5 | 2.8 | 3.6 | 3.2 | 4.1 | 3.7 | 4.5 | 4.5 | 4.2 | 3.9 |
| evaluation | in texture | | | | | | | | | | | | |
| | Elasticity | 1.8 | 2.0 | 2.1 | 2.5 | 2.8 | 2.7 | 3.2 | 3.0 | 3.2 | 3.4 | 3.5 | 3.3 |
| | Smoothness | 1.0 | 1.5 | 1.8 | 2.6 | 2.9 | 2.7 | 3.3 | 3.0 | 3.4 | 3.8 | 4.4 | 4.9 |

| Raw material composition | | Manufacturing Examples | | | |
|---|---|---|---|---|---|
| (parts by mass) | | 1-7 | 1-8 | 1-9 | 1-10 |
| Moderate wheat flour | | 65 | 50 | 65 | 50 |
| Acetylated glutinous potato starch | | 35 | 50 | | |
| Etherified glutinous potato starch | | | | 35 | 50 |
| Gluten | | | 3 | | 3 |
| Noodle thickness (mm) | | 0.9 | 0.9 | 0.9 | 0.9 |
| Reconstituting time (min) | | 3.5 | 3 | 4 | 4 |
| Texture | Unevenness | 4.3 | 4.4 | 4.1 | 4.0 |
| evaluation | in texture | | | | |
| | Elasticity | 3.5 | 3.7 | 3.5 | 3.9 |
| | Smoothness | 3.8 | 4.1 | 4.2 | 4.7 |

### [Test Example 2] Non-Fried Instant Noodles

Raw noodle strings were prepared in the same procedure as in 1) of Test Example 1 using the raw material powders described in Table 2. The obtained raw noodle strings were steamed for 3 minutes (steaming pressure: 3 to 8 kPa), then divided into individual meals, and dried with hot air at 130° C. for 8 minutes to manufacture non-fried instant noodles (Chinese noodles). The manufactured instant noodles were evaluated by the same 10 panelists in the same procedure as in 2) of Test Example 1. The evaluation results are shown in Table 2.

TABLE 2

| | | Comparative | | | |
|---|---|---|---|---|---|
| Raw material composition | | Example | Manufacturing Examples | | |
| (parts by mass) | | 2-1 | 2-1 | 2-2 | 2-3 |
| Moderate wheat flour | | 100 | 65 | 65 | 65 |
| Glutinous potato starch | | | 35 | | |
| Acetylated glutinous potato | | | | 35 | |
| starch | | | | | |
| Etherified glutinous potato | | | | | 35 |
| starch | | | | | |
| Noodle thickness (mm) | | 0.9 | 0.9 | 0.9 | 0.9 |
| Reconstituting time (min) | | 30 | 7 | 5 | 6 |
| Texture | Unevenness | 1.2 | 3.6 | 4.0 | 3.8 |
| evaluation | in texture | | | | |
| | Elasticity | 1.5 | 3.5 | 3.8 | 3.7 |
| | Smoothness | 1.0 | 3.6 | 4.0 | 4.3 |

1. A method for manufacturing instant noodles to be reconstituted with water, comprising:
preparing raw noodle strings each having a thickness of 0.93 mm or less from a raw material powder comprising wheat flour and one or more kinds of glutinous starch selected from the group consisting of glutinous potato starch and glutinous tapioca starch,
wherein a mass ratio of the wheat flour and the glutinous starch in the raw material powder is from 65:35 to 15:85.

2. The method of claim 1, wherein the glutinous starch comprises an esterified starch or an etherified starch.

3. The method of claim 1, wherein the instant noodles to be reconstituted with water are instant noodles to be reconstituted with water at a temperature of 30° C. or lower.

4. The method of claim 1, further comprising:
pregelatinizing the raw noodle strings, and then frying or drying the raw noodle strings.

5. The method of claim 4, wherein the instant noodles are fried instant noodles.

6. The method of claim 1, wherein the wheat flour comprises wheat flour derived from medium hard wheat as a main component.

7. The method of claim 1, wherein a total amount of the wheat flour and the glutinous starch in the raw material powder is 80 mass % or more.

8-14. (canceled)

15. A method for manufacturing instant noodles, comprising:
bringing the instant noodles manufactured by the method of claim 1 into contact with water at normal temperature or lower for 10 minutes or shorter to reconstitute the instant noodles to an edible state.
